(19) United States
(12) Patent Application Publication
(10) Pub. No.: US 2016/0019816 A1
(43) Pub. Date: Jan. 21, 2016

(54) Language Learning Tool

(71) Applicant: Nimble Knowledge, LLC, Alpine, UT (US)

(72) Inventors: Kent Parry, Alpine, UT (US); Dan Masterson, Alpine, UT (US)

(21) Appl. No.: 14/801,752

(22) Filed: Jul. 16, 2015

Related U.S. Application Data
(60) Provisional application No. 62/025,440, filed on Jul. 16, 2014.

(51) Int. Cl. G09B 19/06; G09B 5/06; G06F 17/28

(52) U.S. Cl. CPC G09B 19/06; G06F 17/289; G09B 5/06

(57) ABSTRACT

A technology is described for a language learning tool. An example method may include obtaining a user profile from a data store in response to a request to provide text used to study a target language. Target language words recognized by the user that correspond with a source language words included in the text may then be identified from the user profile. Instances of the source language words may then be replaced in the text with the target language words identified from the user profile and the text may be provided to a client device. A selection of a displayed word may be received from the client device, whereupon a corresponding word in either the source language or the target language may be identified to replace the displayed word in the text displayed on the client device.

### BACKGROUND

Language acquisition is the process of acquiring the capacity to perceive and comprehend a language, as well as to produce and use words and sentences to communicate in the language. Successfully learning a language may involve acquiring a range of tools including phonology, morphology, syntax, semantics, and an extensive vocabulary.

Various tools may be used to learn a language. A multi-language weave is a language learning technique that may be used to help a student memorize foreign words. The multi-language weave technique may include “weaving” foreign words into the student's native language by using the foreign words in place of a corresponding native word. The frequency of foreign words may be gradually increased as the student progresses in memorizing the foreign words.

### BRIEF DESCRIPTION OF THE DRAWINGS

FIG. 1 is a diagram illustrating an example system for executing a language learning tool.

FIG. 2 is a block diagram that illustrates various example components included in a system for a language learning tool.

FIGS. 3a and 3b are illustrations of example texts used in a language learning tool.

FIG. 4 is an illustration of example texts used in a language learning tool that display source language words and target language words.

FIG. 5 is an illustration of example learning activities that may be used in a language learning tool.

FIG. 6 is an illustration of an example Cloze learning activity that may be used in a language learning tool.

FIG. 7 is a flow diagram that illustrates an example of a method for a language learning activity.

FIG. 8 is block diagram illustrating an example of a computing device that may be used to execute a method for a language learning activity.

### DETAILED DESCRIPTION

A technology is described for a language learning tool. In one example configuration, text (e.g., a sentence or paragraph) may be displayed to a user via an electronic display in a sentence structure of a target language (i.e., the language that the user wishes to learn) where words of the text are displayed in the native language of the user or a source language selected by the user (i.e., a language that the user understands). The user may interact with the text by selecting a displayed word, whereupon the displayed word may be replaced with a corresponding word in the target language. For example, where the user's native language is English and the target language is Spanish, the word “friend” in the text would be replaced with the word “amigo”. The user may be provided with the ability to toggle back and forth between the source (e.g., a native language) language word and the target language word by selecting the respective word displayed on the electronic display. A target language may be any spoken or written language and is not limited to the examples provided herein.

A user profile may be assigned to a user that may record the user's progress in learning a target language. When a user selects a word in a text, the user's word selection may be recorded to the user profile. As such, the user's progress may be recorded in the user profile. More specifically, when the user selects a word in their native language to replace with a word in the target language, the technology records that the user has learned or “knows” the target language word. As a result, when a text is loaded and displayed to the user, the user profile may be referenced to determine which target language words the user is assumed to know. Source language (e.g., native language) words in the text may be replaced with corresponding target language words identified in the user profile. As such, when the text is displayed to the user, the text may contain both source language words and target language words the user is presumed to know.

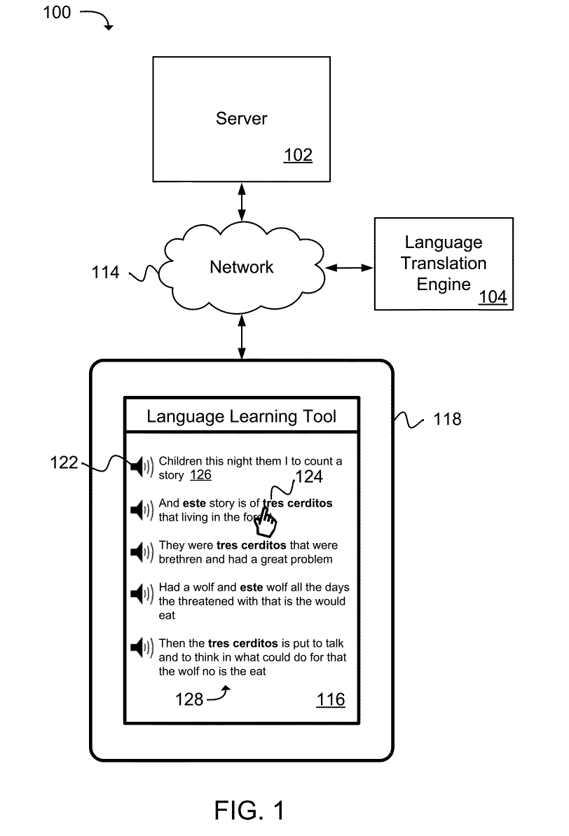

FIG. 1 is a diagram illustrating a high level example of a system environment 100 that may be used for executing a language learning tool as described herein. The language learning tool may comprise a network application (e.g., a web application) executed on a server 102 or a mobile application executed on a mobile device. As illustrated, the system 100 may include a server 102 in communication via a network 114 with a number of client devices 118. The client devices 118 may be used to request a learning activity 116 from the server 102 and display the learning activity 116 on the client device's display. The server 102 may also be in communication by way of the network 114 with one or more translation engines 104 used to obtain a word-for-word translation of text 128 used within the language learning tool as described below.

In one example configuration, the server 102 may receive a request from a client device 118 for a language learning activity. In response to the request, the server 102 may provide the client device 118 with text 128 (e.g., a sentence, paragraph, story, etc.) that is in a source language (e.g., a language understood by a user or a user's native language). The sentence structure of the text 128 may be in a sentence structure of a target language. For example, where the target language is Spanish, the sentence structure may be a Spanish language structure. As a specific example, a text 128 provided may be in a source language of English and a sentence structure of Spanish and may read as “Children this night them I to count a story”, as opposed to an English sentence structure of “Children tonight I will tell you a story”.

In another example, a text 128 may be initially provided to a client device 118 in a sentence structure of a source language. After a user has toggled a sufficient number or certain percentage of source language words are changed or toggled to target language words in the text 128, the sentence structure of the text 128 may be changed from the sentence structure of the source language to a sentence structure of the target language. In other word, the sentence structure may flip from the source language to the target language.

Upon receiving a learning activity from the server 102, the client device 118 may display the learning activity 116, allowing a user to interact with the text 128 of the learning activity. In one example configuration, a user may interact with a learning activity 116 by selecting individual words displayed in the learning activity 116. When a word 124 is selected, a corresponding word either in a source language or a target language may replace the word 124 selected by the user. For example, selecting a word 124 displayed in a source language may result in the word 124 being replaced with a corresponding word 124 in a target language. Selecting a word 124 displayed in a target language would result in the word 124 being replaced with a corresponding word 124 in a source language. As a specific example, where a source language is English and a target language is Spanish, selecting the English source word “three” would result in replacing the English source word with a corresponding Spanish target word “tres”. Likewise, selecting the Spanish target word “tres” would result in replacing the Spanish target word with the English source word “three”.

In addition, selecting a word 124 in the text may cause replacement of instances of the word 124 with the corresponding word everywhere in the text. Thus, as in the example above, selecting the English source word “three” would cause every instance of “three” to be replaced with the Spanish target word “tres”. In some example configurations, instances of the word may be replaced not only in the text, but throughout the user's library, which may be multiple books or articles. More specifically, the instances of the word in the texts associated with the user's profile may change.

Also, a user may be provided with the ability to interact with the learning activity 116 by selecting a control 122 displayed on the client device 118 that causes an audio file associated with a word, sentence 126, paragraph, etc. to be played via a client device's audio system. This control 122 allows the user to hear the text in the target language. As the user progresses in learning the language, the user may view fewer and fewer words in the source language and this can help improve the user's overall oral comprehension and vocabulary together. In addition, a text-to-speech service may be used that allows a user to select the control 122 to hear audio playback of a sentence 126, text 128, etc. in a multi-language weave form (i.e., the combination of native language/source language words and target language words).

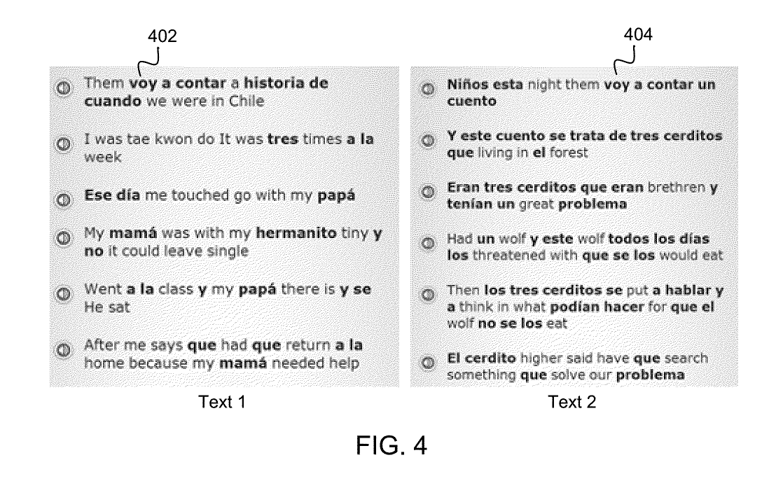

A user profile associated with a user may be used to record a user's progress in learning a target language. In one example configuration, a language state of a word 124 may be recorded to the user profile, indicating a user's progress in learning the word 124 (i.e., the user has or has not learned the word in the target language). For example, the language state of a word 124 may indicate whether the word 124 is displayed to a user in a learning activity 116 in a native language/source language or in a target language. As one example, upon a user selecting a word 124, a request may be sent from the client device 118 to the server 102 via an API (Application Programming Interface) to add a target language word to the user profile. Adding the target language word to the user profile may indicate that the user has learned the target language word, as such, after a user has selected a word for display in a target language, learning activities provided to the user that contain a corresponding word in a native language/source language will have the word in the native language/source language replaced with the target language word, as is illustrated in FIG. 4.

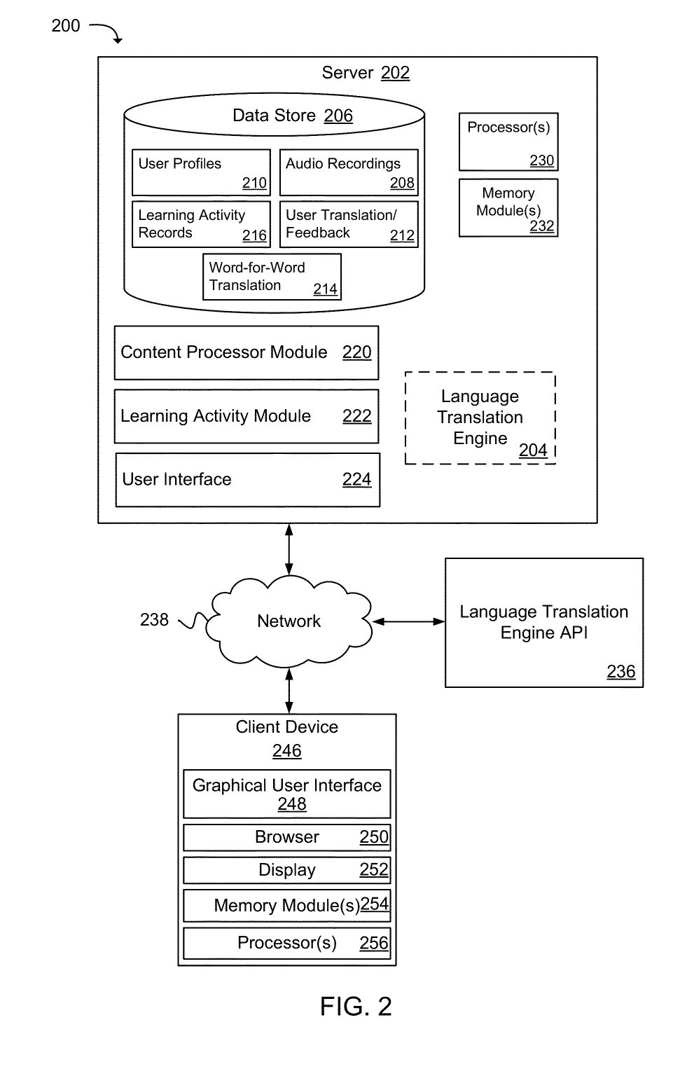

FIG. 2 illustrates components of an example system 200 on which the present technology may be executed. The system 200 may include a server computer 202 that may be in communication with a number of client devices 246 and a third party translation engine API 236 via a network 238. The server computer 202 may contain a data store 206, a content processor 220 and a learning activity module 222.

The content processor 220 may be used to process data records containing language activity content. In one example configuration, language activity content used to teach a target language may be produced by recording conversations between native speakers of the target language. The recordings may include stuttering, sentence fragments, false starts, dropped words, slurring, slang, and/or incorrect grammar. A benefit of producing content in this way may be to illustrate how native speakers speak and may prepare a user to understand native speech in an actual setting. A script may then be prepared that is a transcript of a story or a dialog captured between the native speakers. The script may be created by voice recognition software or the script may be created by human transcription. A cleaned-up transcript (e.g. summary transcript) may be presented in grammatically correct English and recorded with correct pronunciation. As a result, the user may experience both a cleaned-up transcript version and an original transcript version of the conversation between the native speakers.

In another example configuration, language activity content used to teach a target language may be obtained from various network sources, such as a third party web server. The language activity content retrieved may then be immediately processed for use in a language activity.

In addition, learning activity content may be scripted in a source language and then translated to a target language, which may then be recorded to an audio format within a controlled environment using trained readers, thereby producing learning activity content that includes correct pronunciation and articulation. Also, existing content used to teach a target language may be obtained from affiliated partners. The content obtained from a recording, a text and/or existing content obtained from one or more partners may be processed using the content processor module 220 and stored in the data store 206 as a learning activity record 216. As a specific example, a learning activity record 216 may be created that includes: the target language, the source language, the title of the content in the source language (e.g., Accident stories), the title of the content in the target language (e.g., Historias de accidentes), the name and file path of a language learning audio file, the name of the speaker(s) featured in the audio file, a target language transcription of the audio file and a source language transcription of the audio file.

After creating the learning activity record 216, in one example, a word-for-word translation of the target language transcription included in the learning activity record 216 may be performed using the content processor module 220. For instance, the word-for-word translation may be performed by analyzing the target language transcription and extracting the individual words from the target language transcription. The words may then be provided to a third party language translation engine API 236 or another translation engine 204 that provides a word-for-word translation 214 (as opposed to a translation of a target language phrase). The word-for-word translation 214 may be stored in the data store 206 in a glossary making the word-for-word translation 214 available for use in the learning activity (i.e., replacing a source language word with a word-for-word translation 214).

After adding a learning activity record 216 to the data store 206, base leveling for the learning activity record 216 may be performed. For example, base leveling may be based in part on phrase length, characters per phrase, and percentage of words not on a word frequency list. After the learning activity record 216 is assigned an initial base level, the level may change and become individualized based on what the user knows. For example, a learning activity 216 may receive an initial base level, but the level may be increased or decreased based on a user's, or a number of user's language knowledge. As a specific example, a learning activity 216 with a base level of 2 may have the level decreased to 1 if determined that users are completing the learning activity 216 in a short period of time.

The learning activity module 222 may be used to record which vocabulary (e.g., target language words) the user knows. For example, when a user selects a source language word resulting in the source language word being replaced with a corresponding target language word, a user profile 210 for the user may be updated with the target language word to show that the user knows the target language word. In a case where a user selects a target language word, resulting in the target language word being replaced with a corresponding source language word, the target language word may be removed from a user profile 210 associated with the user, indicating that the user does not know the target language word.

In one example, when a user accesses the language learning tool via a user interface 224, available learning activities sequenced by level may be displayed to the user according to a learning activity level. The user may view learning activities by level, alphabetically, or by topic. Once a user chooses a learning activity, the user can navigate to a learning area that shows a phrase, a natural translation, and a word-for-word translation. The user can listen to the phrase via an audio recording 208.

In some examples, a user may be tested to identify a language learning level for the user based in part on target language words that the user has been tested as recognizing. The language learning level identified may be recorded to a user profile associated with the user. Based on the language learning level identified for a user, learning activities assigned the language learning level may be provided to the user.

In one example configuration, users may provide target language translations 212 for source language words and/or combinations of source language words (e.g., work out) via an API (not shown). For example, target language translations for some source language words obtained from a third party language translation engine APIs 236 or other language translation engines 204 may not be correct. User's recognizing that a target language translation is not correct may submit a target language translation 212 to the system. Likewise, a user may submit user feedback 212 as to whether a target language translation for a source language word or combination of source language words is correct.

A client device 246 may include any device capable of sending and receiving data over a communications network 238. A client device 246 may comprise, for example a processor-based system such as a computing device. Such a computing device may contain one or more processors 256, one or more memory modules 254 and a graphical user interface 248. A client device 246 may be a device such as, but not limited to, a desktop computer, laptop or notebook computer, tablet computer, handheld computer, smartphone, or other devices with like capability. A client device 246 may include a browser 250 that may enable the client device 246 to access the server 202 by way of a server side executed user interface 224. The client device 246 may include a display 252, such as a liquid crystal display (LCD) screen, gas plasma-based flat panel display, LCD projector, cathode ray tube (CRT), or other types of display devices, etc.

The various processes and/or other functionality contained on the server 202 may be executed on one or more processors 230 that are in communication with one or more memory modules 232 according to various examples. The server 202 may comprise, for example, of a computing device or any other system providing computing capability. Alternatively, a number of computing devices may be employed that are arranged, for example, in one or more server banks or computer banks or other arrangements. For purposes of convenience, the server 202 is referred to in the singular. However, it is understood that a plurality of servers 202 may be employed in the various arrangements as described above.

The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

The network 238 may include any useful computing network, including an intranet, the Internet, a local area network, a wide area network, a wireless data network, or any other such network or combination thereof. Components utilized for such a system may depend at least in part upon the type of network and/or environment selected. Communication over the network may be enabled by wired or wireless connections and combinations thereof.

FIG. 2 illustrates that certain processing modules may be discussed in connection with this technology and these processing modules may be implemented as computing services. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that are hosted in a server, virtualized service environment, grid or cluster computing system. An API may be provided for each module to enable a second module to send requests to and receive output from the first module. Such APIs may also allow third parties to interface with the module and make requests and receive output from the modules. While FIG. 2 illustrates an example of a system that may implement the techniques above, many other similar or different environments are possible. The example environments discussed and illustrated above are merely representative and not limiting.

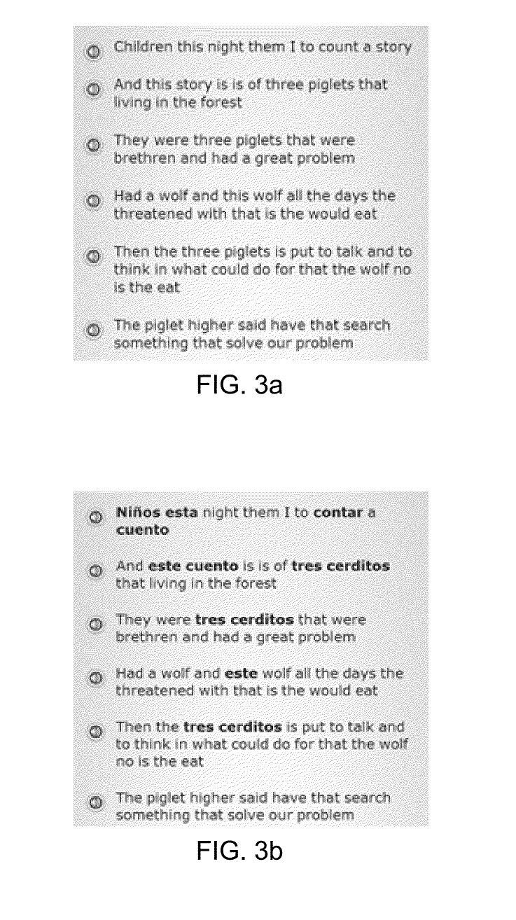

FIGS. 3a and 3b illustrate an example of a learning activity that may be provided to a user via a language learning tool. The learning activity shown illustrates the use of a language learning technique called multi-language weave. The learning technique helps users memorize target language words by “weaving” the target language words into the user's native language or some other source language. In a diglot, the frequency of target language words may be gradually increased as the user progresses through a text. Once a new target language word is introduced, that target language word may be used in place of the native word or source language word throughout the remainder of the text.

As an illustration, the sentence in a source language may be: “Today I'm going to tell you a story about a beautiful young woman.” Whereas, the same sentence in a diglot may be: “Today I'm going to tell you una historia about a beautiful young woman.” The source language words “a story” were replaced with the Spanish target language words “una historia”.

The present technology weaves together two languages (i.e., a source language and a target language) throughout the text, allowing a user to determine which target language words are introduced at what sequence and frequency. For example, upon launching a learning activity, a user may see the textual content in either the user's native language or a source language selected by the user. A sentence structure of the textual content may be of the target language or the source language. The user may select (e.g., click, touch, etc.) a word in the sentence that the user does know and the word may be toggled to the equivalent word in the target language. Once the user selects a word, an assumption may be made that the user knows that word. If the user toggles the word back, an assumption may be made that the user does not know the word. The technology records each time that the user toggles on or toggles off a word. When a user toggles on a word, the word may be replaced throughout the text. In the case that the user opens another learning activity in the future, the textual content displayed may include the words the user already knows in the target language.

Returning to FIGS. 3a and 3b, an example of “The Three Pigs” for a native English speaker learning Spanish is shown in FIG. 3a. In this example, a native English speaker starts with the story in English, and although the English speaker can read the words; the sentence structure is incorrect for English, but is correct for Spanish. In FIG. 3b several of the words in the story have been toggled from original English to a Spanish equivalent. A user can toggle back and forth between the native language/source language words and the target language words, word-by-word.

FIG. 4 demonstrates how changes recorded in one text may be stored in a user profile and may be reflected in subsequent texts displayed to a user. As illustrated in FIG. 4, a user may select a word 402 in one text, and then open another text to find that the source language word is toggled to the target language word 404. By toggling a word to the target language word, the user indicates that the user knows that word, and the word may be replaced with the target language word thereafter regardless of which text the user may be reading.

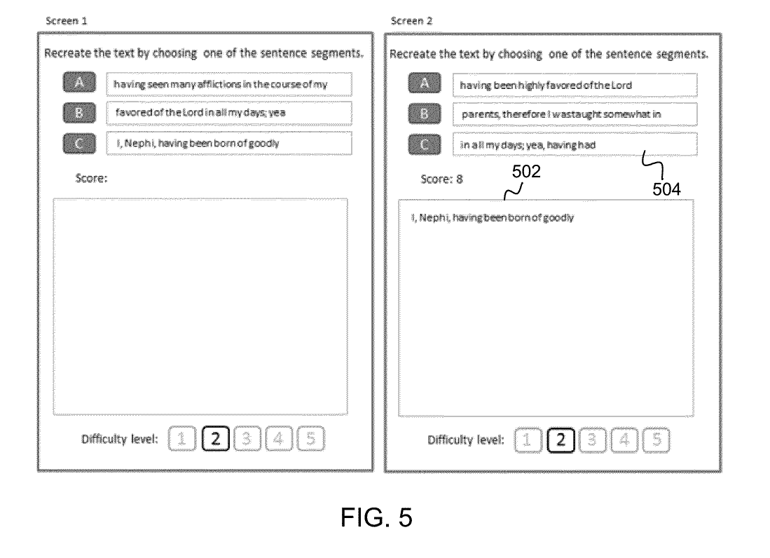

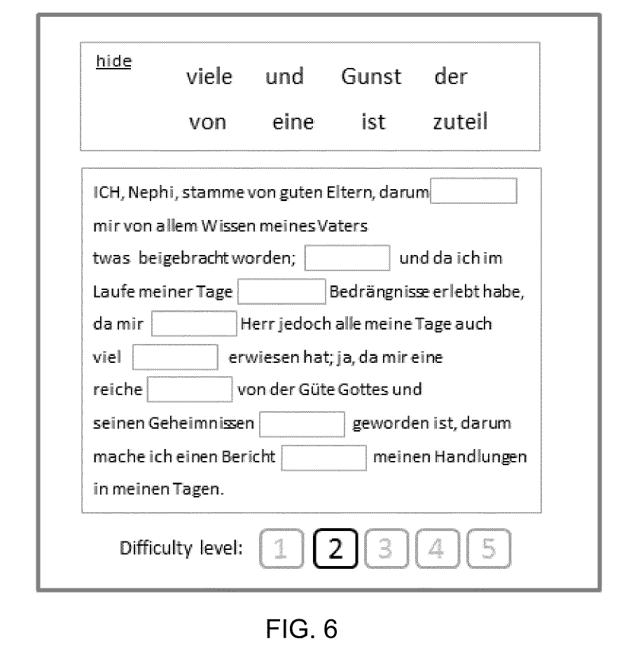

FIGS. 5 and 6 illustrate various examples of learning activities that may be provided via a language learning tool. Once language learning content has been collected and processed as explained earlier in relation to FIG. 2, the language learning content may be used in a variety of activities. FIG. 5 illustrates two examples of a learning activity that may utilize the language learning content. In the activity illustrated, a user may be presented with sentence segments and given the opportunity to build a paragraph by selecting which order the sentence segments should appear in. The user may be given a score based on performance. When the correct sentence segment is selected, that sentence segment may appear in a text box 502 and a new sentence segment may appear in a multiple choice area 504. The user may determine the difficulty level by changing the length of each segment; the shorter the length, the harder the learning activity. For example, level 1 may be 15 to 18 words, level 2 may be 11 to 14 words, etc., with the most difficult being 1 to 4 words.

In some examples, language learning games and language learning activities may be based in part on a method that identifies which words in a text have been toggled, as well as how frequently and recently the words have been toggled. The words identified may then be incorporated into the language learning games and language learning activities. In addition, points may be awarded based on a number of words that have been toggled and reports may be provided to a user based in part on a number of words that have been toggled by the user.

FIG. 6 illustrates another example of a learning activity that may be provided via a language learning tool. The activity is what Linguists may refer to as a Cloze activity, where every nth word is made into a blank, regardless of the size of that word. A user may determine the difficulty level, which will change the value of n.

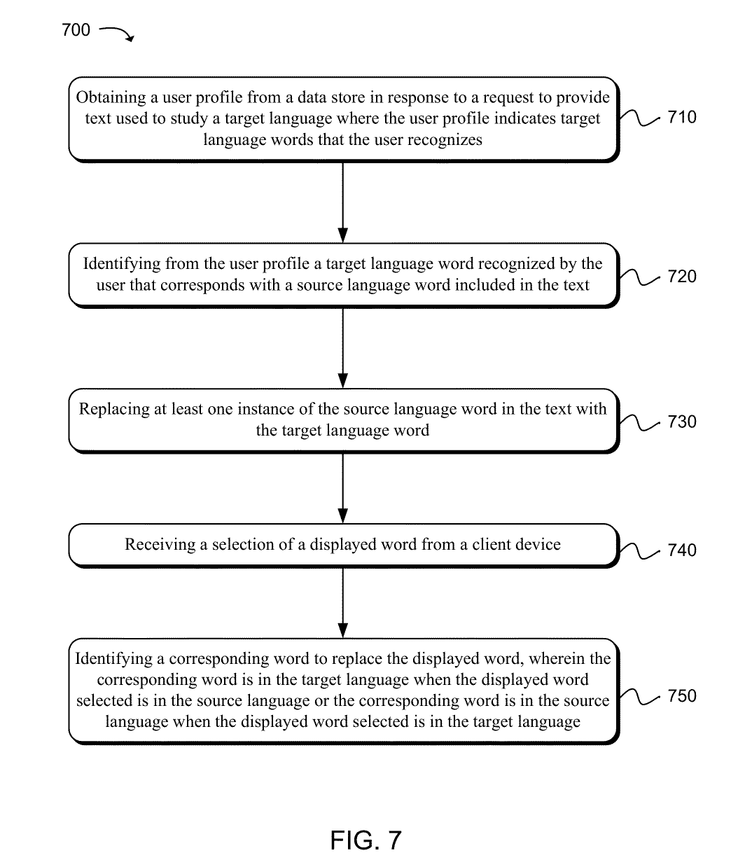

FIG. 7 is a flowchart illustrating an example of a method 700 for a language learning tool. Beginning in block 710, a user profile may be obtained from a data store in response to a request to provide text used to study a target language. Included in the user profile may be target language words that a user recognizes.

As in block 720, a target language word recognized by the user that corresponds with a source language word included in the text may be identified from the user profile. The target language word, as in block 730, may be used to replace instances of the source language word in the text. The text may then be provided to a requesting client device, where a user may interact with the text via a graphical user interface.

As in block 740, a selection of a displayed word may be received from a client device. The selected displayed word may be a word either in a source language or a target language that a user wishes to toggle to a corresponding word. As in block 750, a corresponding word to replace the displayed word may be identified where the corresponding word is in the target language when the displayed word selected is in the source language, or the corresponding word is in the source language when the displayed word selected is in the target language.

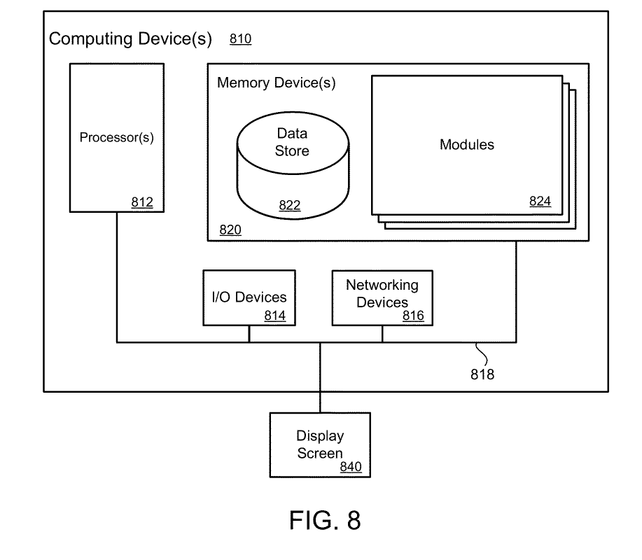

FIG. 8 illustrates a computing device 810 on which modules of this technology may execute. A computing device 810 is illustrated on which a high level example of the technology may be executed. The computing device 810 may include one or more processors 812 that are in communication with memory devices 820. The computing device 810 may include a local communication interface 818 for the components in the computing device. For example, the local communication interface 818 may be a local data bus and/or any related address or control busses as may be desired.

The memory device 820 may contain modules 824 that are executable by the processor(s) 812 and data for the modules 824. Examples of modules 824 may include a content processor module and a learning activity module. The modules 824 may execute the functions described earlier. A data store 822 may also be located in the memory device 820 for storing data related to the modules 824 and other applications along with an operating system that is executable by the processor(s) 812.

Other applications may also be stored in the memory device 820 and may be executable by the processor(s) 812. Components or modules discussed in this description that may be implemented in the form of software using high programming level languages that are compiled, interpreted or executed using a hybrid of the methods.

The computing device may also have access to I/O (input/output) devices 814 that are usable by the computing devices. An example of an I/O device may be a display screen that is available to display output from the computing devices. Networking devices 816 and similar communication devices may be included in the computing device. The networking devices 816 may be wired or wireless networking devices that connect to the internet, a LAN, WAN, or other computing network.

The components or modules that are shown as being stored in the memory device 820 may be executed by the processor(s) 812. The term “executable” may mean a program file that is in a form that may be executed by a processor 812. For example, a program in a higher level language may be compiled into machine code in a format that may be loaded into a random access portion of the memory device 820 and executed by the processor 812, or source code may be loaded by another executable program and interpreted to generate instructions in a random access portion of the memory to be executed by a processor. The executable program may be stored in any portion or component of the memory device 820. For example, the memory device 820 may be random access memory (RAM), read only memory (ROM), flash memory, a solid state drive, memory card, a hard drive, optical disk, floppy disk, magnetic tape, or any other memory components.

The processor 812 may represent multiple processors and the memory 820 may represent multiple memory units that operate in parallel to the processing circuits. This may provide parallel processing channels for the processes and data in the system. The local interface 818 may be used as a network to facilitate communication between any of the multiple processors and multiple memories. The local interface 818 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, non-transitory media such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method for a language learning tool, comprising:
under control of one or more computer systems configured with executable instructions,
providing words in a sentence structure of a target language that are displayable on an electronic display and the words are displayable in a source language of a user or the target language according to a user profile indicating a language state for the words
receiving a selection of a displayable word causing the displayable word to be replaced with:
a corresponding word in the target language when the displayable word selected is in the source language;
a corresponding word in the source language when the displayable word selected is in the target language; and
recording the language state of a selected word to the user profile, using a processor, wherein the language state is used to determine whether to display a word in the target language or in the source language when displaying text to the user.

2. A method for a language learning tool as in claim 1, further comprising playing an audio recording of the words in the sentence structure when a user selects an audio playback control.

3. A method for a language learning tool as in claim 1, further comprising replacing instances of the displayable word selected by the user with the corresponding word everywhere in a source text containing the words.

4. A method for a language learning tool as in claim 1, wherein displaying words on the electronic display further comprises a multi-language weave allowing a user to toggle between a native language word and a target language word.

5. A computer implemented method, comprising:
obtaining a user profile from a data store in response to a request to provide text used to study a target language, using a processor, where the user profile indicates target language words that the user recognizes;
identifying from the user profile a target language word recognized by the user that corresponds with a source language word included in the text, using the processor;
replacing at least one instance of the source language word in the text with the target language word, using the processor; and
receiving a selection of a displayed word from a client device; and
identifying a corresponding word to replace the displayed word, using the processor, wherein the corresponding word is in the target language when the displayed word selected is in the source language or the corresponding word is in the source language when the displayed word selected is in the target language.

6. A method as in claim 5, further comprising receiving a request via an API (Application Programming Interface) to add a target language word to the user profile that the user recognizes.

7. A method as in claim 5, further comprising receiving a request via an API to remove a target language word from the user profile.

8. A method as in claim 5, further comprising querying a third party translation engine to obtain target language words corresponding to native language words.

9. A method as in claim 5, further comprising identifying a language learning level for the user based at least in part on the target language words that the user has been tested as recognizing.
